(19) United States
(12) Patent Application Publication
(10) Pub. No.: US 2025/0170825 A1
(43) Pub. Date: May 29, 2025

(54) LIQUID-DISCHARGE-HEAD DRIVING DEVICE, LIQUID-DISCHARGE-HEAD DRIVING SYSTEM, LIQUID DISCHARGE APPARATUS, LIQUID-DISCHARGE-HEAD DRIVING METHOD, AND RECORDING MEDIUM

(71) Applicant: Takeya SATOH, Kanagawa (JP)

(72) Inventor: Takeya SATOH, Kanagawa (JP)

(73) Assignee: Ricoh Company, Ltd., Tokyo (JP)

(21) Appl. No.: 18/948,908

(22) Filed: Nov. 15, 2024

(30) Foreign Application Priority Data
Nov. 29, 2023 (JP) 2023-202114

(51) Int. Cl. B41J 2/045; B41J 2/165

(52) U.S. Cl. CPC B41J 2/04588; B41J 2/04541; B41J 2/04561; B41J 2/04581; B41J 2/16535

(57) ABSTRACT

A liquid-discharge-head driving device includes processing circuitry and a memory. The processing circuitry generates a drive signal based on voltage information on a voltage applied to a piezoelectric element of nozzles of a liquid discharge head and outputs the drive signal to the liquid discharge head, and acquires, based on droplet speed information acquired from a droplet speed measuring device that measures a discharge speed of a droplet discharged from the liquid discharge head and the voltage information, appropriate voltage information on a voltage at which the discharge speed falls within a predetermined range. The memory stores the appropriate voltage information in association with identification information of the nozzles and a drive frequency of the nozzles. The processing circuitry acquires, from the memory, the appropriate voltage information corresponding to the identification information and the drive frequency and outputs the drive signal based on the appropriate voltage information.

### CROSS-REFERENCE TO RELATED APPLICATION

This patent application is based on and claims priority pursuant to 35 U.S.C. § 119 (a) to Japanese Patent Application No. 2023-202114, filed on Nov. 29, 2023, in the Japan Patent Office, the entire disclosure of which is hereby incorporated by reference herein.

### BACKGROUND

### Technical Field

The present disclosure relates to a liquid-discharge-head driving device, a liquid-discharge-head driving system, a liquid discharge apparatus, a liquid-discharge-head driving method, and a recording medium.

### Related Art

A droplet discharge device has a characteristic that the discharge speed of a droplet from a nozzle changes depending on the drive frequency. In order to reduce this change in discharge speed, a technique has been developed that changes, for example, the drive voltage or drive waveform of the head according to the drive frequency.

Further, an inkjet head of the droplet discharge device has a characteristic that a plurality of nozzles is mounted in one row, and the discharge speed is different between a central portion and an end portion of the row. The inkjet head has been designed to such an extent that the difference in discharge speed between the central portion and the end portion of the row does not cause a disadvantage. However, as the drive frequency of the head becomes higher and the frequency band of driving of the head becomes wider, it becomes difficult to reduce the difference in discharge speed between the central portion and the end portion of the row to such an extent that the difference does not cause a disadvantage in the entire band. Then, for example, a technique has been proposed for correcting the difference in discharge speed between a central portion and an end portion of a row with two types of drive waveforms of the head in a row of nozzles.

### SUMMARY

The present disclosure described herein provides a liquid-discharge-head driving device for driving a liquid discharge head including a plurality of nozzles to discharge liquid according to a drive signal input to the liquid discharge head. The liquid-discharge-head driving device includes processing circuitry and a memory. The processing circuitry generates the drive signal based on voltage information on a voltage applied to a piezoelectric element of the nozzles and outputs the drive signal to the liquid discharge head, and acquires, based on droplet speed information acquired from a droplet speed measuring device that measures a discharge speed of a droplet discharged from the liquid discharge head and the voltage information, appropriate voltage information on a voltage at which the discharge speed falls within a predetermined range. The memory stores the appropriate voltage information in association with identification information of the nozzles and a drive frequency of the nozzles. The processing circuitry acquires, from the memory, the appropriate voltage information corresponding to the identification information and the drive frequency and outputs the drive signal based on the appropriate voltage information.

The present disclosure described herein also provides a liquid-discharge-head driving system that includes the liquid-discharge-head driving device and a droplet speed measuring device to communicate with the liquid-discharge-head driving device. The droplet speed measuring device includes a camera to move with respect to the liquid discharge head and measure a discharge speed of liquid for each of the nozzles of the liquid discharge head.

The present disclosure described herein further provides a liquid discharge apparatus that includes the liquid discharge head and the liquid-discharge-head driving device. The liquid discharge head discharges liquid according to the drive signal input to the liquid discharge head. The liquid-discharge-head driving device drives the liquid discharge head.

The present disclosure described herein further provides a liquid-discharge-head driving method to be executed by a liquid-discharge-head driving device that drives a liquid discharge head including a plurality of nozzles to discharge liquid according to a drive signal input to the liquid discharge head. The liquid-discharge-head driving method includes: generating the drive signal based on voltage information on a voltage applied to a piezoelectric element of the nozzles and outputting the drive signal to the liquid discharge head; acquiring, based on droplet speed information acquired from a droplet speed measuring device that measures a discharge speed of a droplet discharged from the liquid discharge head and the voltage information, appropriate voltage information on a voltage at which the discharge speed falls within a predetermined range; and acquiring, from a memory that stores the appropriate voltage information in association with identification information of the nozzles and a drive frequency of the nozzles, the appropriate voltage information corresponding to the identification information and the drive frequency and outputting the drive signal based on the appropriate voltage information.

The present disclosure described herein further provides a computer-readable, non-transitory recording medium storing program code for causing one or more processors to execute: generating, based on voltage information on a voltage applied to a piezoelectric element of nozzles in a liquid discharge head that discharges liquid according to a drive signal input to the liquid discharge head, the drive signal and outputting the drive signal to the liquid discharge head; acquiring, based on droplet speed information acquired from a droplet speed measuring device that measures a discharge speed of a droplet discharged from the liquid discharge head and the voltage information, appropriate voltage information on a voltage at which the discharge speed falls within a predetermined range; and acquiring, from a memory that stores the appropriate voltage information in association with identification information of the nozzles and a drive frequency of the nozzles, the appropriate voltage information corresponding to the identification information and the drive frequency and outputting the drive signal based on the appropriate voltage information.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram for describing an example of characteristics of a drive frequency of a nozzle at an end portion of a liquid discharge head included in a liquid discharge apparatus according to the present embodiment;

FIG. 2 is a diagram for describing an example of characteristics of drive frequencies in driving of nozzles of all channels (chs) of liquid discharge heads included in the liquid discharge apparatus according to the present embodiment;

FIG. 3 is a diagram for describing an example of characteristics of a discharge speed in one row of nozzles of a liquid discharge head included in the liquid discharge apparatus according to the present embodiment;

FIG. 4 is a diagram illustrating an example of a configuration of an inkjet head control device having a Vj adjustment control circuit according to the present embodiment;

FIG. 5 is a diagram illustrating an example of a configuration of an inkjet head included in the liquid discharge apparatus according to the present embodiment;

FIG. 6 is a diagram for describing an example of measurement processing of a discharge speed of a droplet in the inkjet head control device according to the present embodiment;

FIG. 7 is a flowchart illustrating an example of a flow of measurement processing of the discharge speed of the droplet in the inkjet head control device according to the present embodiment;

FIG. 8 is a flowchart illustrating an example of a flow of measurement processing of the discharge speed of the droplet in the inkjet head control device according to the present embodiment;

FIG. 9 is a diagram for describing an example of measurement processing of a discharge speed in the liquid discharge apparatus according to the present embodiment;

FIG. 10 is a diagram for describing an example of measurement processing of the discharge speed in the liquid discharge apparatus according to the present embodiment;

FIG. 11 is a diagram for describing an example of measurement processing of the discharge speed in the liquid discharge apparatus according to the present embodiment;

FIG. 12 is a diagram for describing an example of measurement processing of the discharge speed in the liquid discharge apparatus according to the present embodiment;

FIG. 13 is a diagram illustrating an example of the discharge speed when inkjet heads (Nos. 0001 and 0002) are driven with a constant drive waveform in the inkjet head control device according to the present embodiment;

FIG. 14 is a diagram illustrating an example of a voltage value map of a drive waveform for correcting the inkjet head in the inkjet head control device according to the present embodiment;

FIG. 15 is a diagram illustrating an example of a drive waveform of an inkjet head (No. 0001) in the inkjet head control device according to the present embodiment;

FIG. 16 is a diagram illustrating an example of a drive waveform of an inkjet head (No. 0002) in the inkjet head control device according to the present embodiment;

FIG. 17 is a diagram illustrating an example of a corrected discharge speed in the inkjet head control device according to the present embodiment;

FIG. 18 is a view schematically illustrating an example of an overall configuration of an inkjet printer which is an example of a liquid discharge apparatus according to the present embodiment; and

FIG. 19 is a view schematically illustrating an example of an overall configuration of an inkjet printer which is an example of a liquid discharge apparatus according to the present embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, embodiments of a liquid-discharge-head driving device, a liquid-discharge-head driving system, a liquid discharge apparatus, a liquid-discharge-head driving method, and a program will be described in detail with reference to the accompanying drawings.

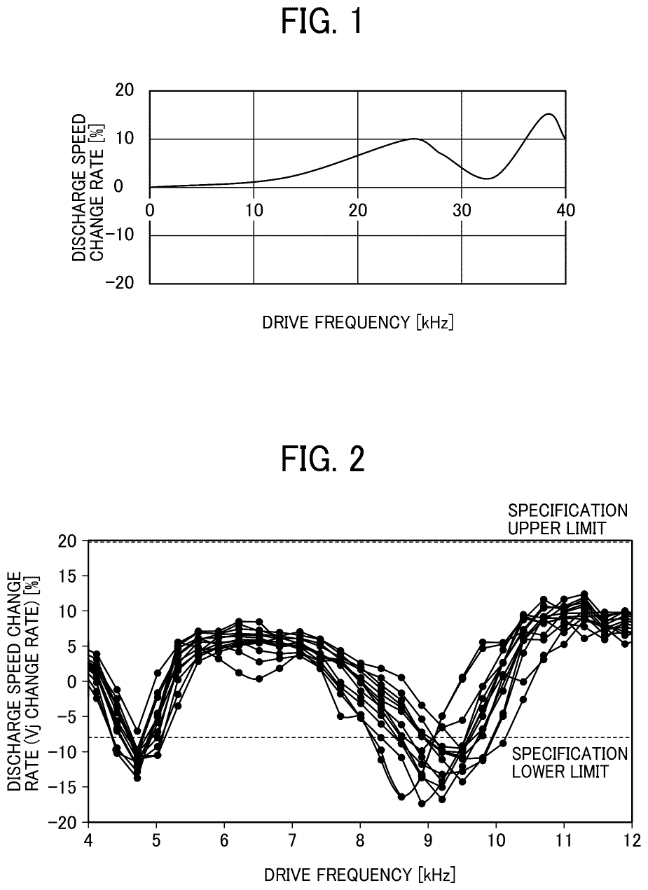

FIG. 1 is a diagram for describing an example of characteristics of a drive frequency of a nozzle at an end portion of a liquid discharge head included in a liquid discharge apparatus according to the present embodiment. In FIG. 1, the vertical axis represents a change rate of a discharge speed (discharge speed change rate) of a liquid discharge head (for example, an inkjet head), and the horizontal axis represents a drive frequency of a nozzle of the liquid discharge head. The example illustrated in FIG. 1 is a characteristic of the drive frequency of the nozzle having a maximum drive frequency of 40 kHz. At 40 kHz or less, the discharge speed of droplets from the nozzle changes depending on the drive frequency.

FIG. 2 is a diagram for describing an example of characteristics of drive frequencies in driving of nozzles of all channels (chs) of liquid discharge heads included in the liquid discharge apparatus according to the present embodiment. In FIG. 2, the horizontal axis represents the drive frequency, and the vertical axis represents the discharge speed change rate. Each plot in FIG. 2 illustrates characteristics of drive frequencies of nozzles located in a central portion of a plurality of nozzle rows included in a plurality of liquid discharge heads. More specifically, FIG. 2 is an example illustrating characteristics of drive frequencies of the nozzles in the central portion of each row for five liquid discharge heads having four nozzle rows. In the liquid discharge head of the example illustrated in FIG. 2, the maximum drive frequency is 40 kHz, but the discharge speed tends to decrease particularly when the drive frequency is equal to or less than 12 kHz. Furthermore, the amount of decrease varies in each liquid discharge head and in each row of the liquid discharge heads. As compared with the characteristics of the drive frequency of the end nozzle of the liquid discharge head illustrated in FIG. 1, in the characteristics of the drive frequencies of the nozzles in the central portion illustrated in FIG. 2, when the drive frequency is 12 kHz or less, the discharge speed of the droplets changes more according to the drive frequency. The difference in the discharge speed can be corrected by changing the drive voltage or the drive waveform of the nozzle according to the drive frequency. However, an environmental temperature in a printing apparatus (an example of the liquid discharge apparatus) and the drive frequency decreased by the type of ink to be used vary for each liquid discharge head. The decreasing discharge speed also varies.

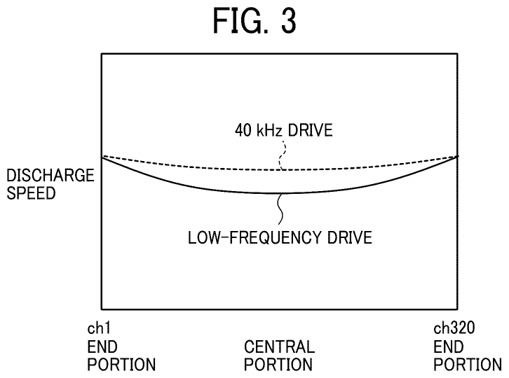

FIG. 3 is a diagram for describing an example of characteristics of the discharge speed in one row of nozzles of a liquid discharge head included in the liquid discharge apparatus according to the present embodiment. In FIG. 3, the horizontal axis represents ch of the nozzles in the row, and the vertical axis represents the discharge speed of droplets. In FIG. 3, a broken line represents the characteristic of the discharge speed at a drive frequency of 40 kHz, and a solid line represents the characteristic of the discharge speed at the time of low-frequency drive and the characteristic of the discharge speed when the drive voltage or the drive waveform is corrected so that the characteristics of the discharge speed of the nozzle at the end of the liquid discharge head at the drive frequency of 40 kHz are the same.

In the case of the low-frequency drive (for example, in the case of a drive frequency of 12 kHz or less illustrated in FIG. 2), the decrease amount of the discharge speed of the nozzle in the central portion of the liquid discharge head is larger than that in the case where the drive frequency is 40 kHz. The lowering amount varies depending on the drive frequency. It is necessary to suppress the lowering amount in the central portion to such an extent that there is no disadvantage in print quality in all drive frequency bands used for printing. In this example, by switching the drive waveform so as to increase the discharge speed in the central portion of the liquid discharge head, the discharge speed difference between the end portion and the central portion of the liquid discharge head can be reduced. However, the environmental temperature in the printing apparatus and the drive frequency that decreases depending on the type of ink to be used vary for each liquid discharge head. The decreasing discharge speed also varies.

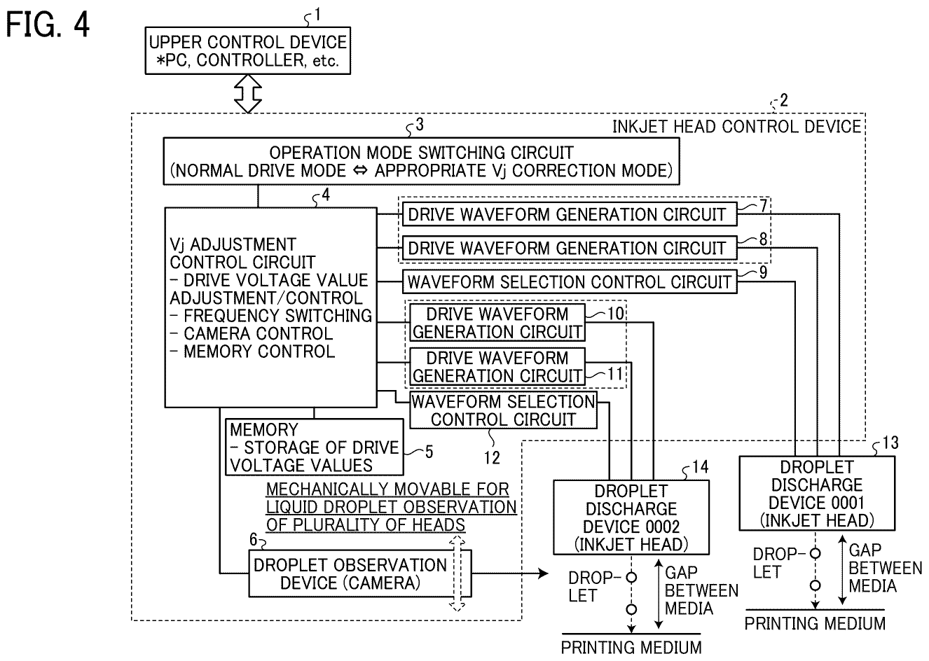

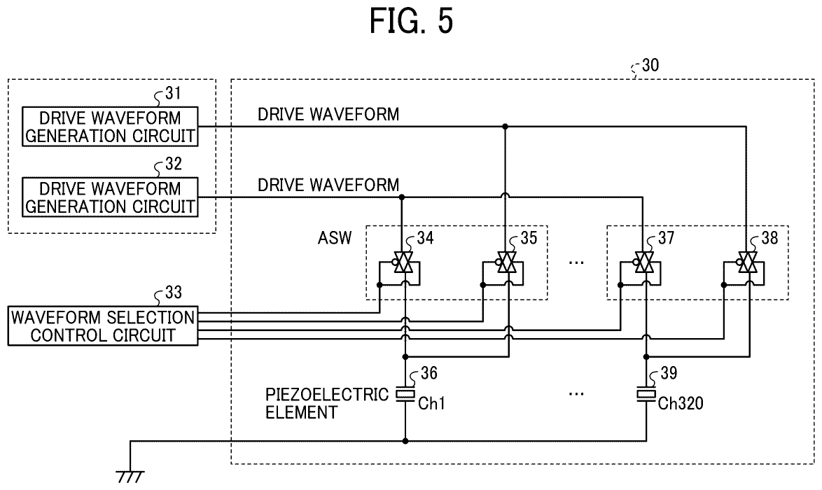

FIG. 4 is a diagram illustrating an example of a configuration of an inkjet head control device having a Vj adjustment control circuit according to the present embodiment. Here, “Vj” of the Vj adjustment control circuit is a term meaning “the speed of a droplet discharged by the liquid discharge head”. FIG. 5 is a diagram illustrating an example of a configuration of an inkjet head included in the liquid discharge apparatus according to the present embodiment. The inkjet head control device 2 is an example of a liquid-discharge-head driving device that drives the first and second droplet discharge devices 13 and 14 (for example, an inkjet head). The first and second droplet discharge devices 13 and 14 are examples of a liquid discharge head including a plurality of nozzles that discharges liquid (droplets of ink or the like) according to an input drive signal. Specifically, the inkjet head control device 2 includes an operation mode switching circuit 3, a Vj adjustment control circuit 4, a memory 5, a droplet observation device 6, a first drive waveform generation circuit 7, a second drive waveform generation circuit 8, waveform selection control circuits 9 and 12, a third drive waveform generation circuit 10, and a fourth drive waveform generation circuit 11.

The operation mode switching circuit 3 switches the operation mode of the inkjet head control device 2 to a normal drive mode or an appropriate Vj correction mode. The first drive waveform generation circuit 7 and the second drive waveform generation circuit 8 are an example of a drive signal output unit that generates a drive signal (drive waveform) on the basis of voltage information on a voltage (voltage value) applied to a piezoelectric element of the nozzle, and outputs the drive waveform to the first droplet discharge device 13. The third drive waveform generation circuit 10 and the fourth drive waveform generation circuit 11 are an example of a drive signal output unit that generates a drive signal (drive waveform) on the basis of voltage information and outputs the drive waveform to the second droplet discharge device 14.

The Vj adjustment control circuit 4 is an example of a voltage information acquisition unit that acquires a voltage value (appropriate voltage information) at which the discharge speed of ink from the first and second droplet discharge devices 13 and 14 falls within a predetermined range on the basis of droplet speed information indicating the discharge speed acquired from the droplet observation device 6 (an example of a droplet speed measuring unit) that measures the discharge speed of ink discharged from the first and second droplet discharge devices 13 and 14 and the voltage information. Here, the Vj adjustment control circuit 4 may acquire the appropriate voltage information for each nozzle included in each of the first and second droplet discharge devices 13 and 14, or may acquire the appropriate voltage information for each of blocks (for example, three blocks of one end portion, a central portion, and the other end portion of the inkjet head) obtained by dividing a plurality of nozzles included in each of the first and second droplet discharge devices 13 and 14.

The Vj adjustment control circuit 4 may acquire the appropriate voltage information on the basis of the droplet speed information and the voltage information when the inkjet head control device 2 transitions from the normal drive mode to the appropriate Vj correction mode (an example of a correction mode). The Vj adjustment control circuit 4 may acquire the appropriate voltage information for each inkjet head. The Vj adjustment control circuit 4 may acquire the appropriate voltage information for each temperature around the inkjet head. The Vj adjustment control circuit 4 may acquire the appropriate voltage information for each type of ink discharged from the inkjet head. Here, the type of ink may be set on the basis of information or the like set by a user.

The memory 5 is an example of a storage unit that stores the appropriate voltage information in association with identification information (ch number or the like) of the nozzle and the drive frequency of the nozzle. The Vj adjustment control circuit 4 is an example of a controller that acquires, from the memory 5, the appropriate voltage information corresponding to the identification information of the nozzle for which the discharge speed of ink and the drive frequency are adjusted, controls the waveform selection control circuits 9 and 12 on the basis of the appropriate voltage information, and causes the first to fourth drive waveform generation circuits 7, 8, 10, and 11 to output the drive waveform. Thus, the difference in the discharge speed between the central portion and the end portion of the row of nozzles can be reduced including a change in the drive frequency of the nozzles of the inkjet head, a variation between inkjet heads, an environmental temperature in the liquid discharge apparatus such as the printing apparatus and a variation in the type of liquid such as the ink to be used, so that the print quality can be improved. The waveform selection control circuits 9 and 12 are controlled by the Vj adjustment control circuit 4, and select drive waveforms to be output to the first and second droplet discharge devices 13 and 14.

The droplet observation device 6 is an example of the droplet speed measuring unit, and includes a camera that measures a droplet. The camera is movable with respect to the first and second droplet discharge devices 13 and 14, and is provided to be able to measure the discharge speed of ink for each nozzle. In the present embodiment, the droplet observation device 6 is provided in the inkjet head control device 2, but may be provided outside the inkjet head control device 2 as long as it can communicate with the inkjet head control device 2 by wireless communication or the like.

Two types of drive waveforms (a first drive waveform and a second drive waveform) are generated by each of the first drive waveform generation circuit 7 and the second drive waveform generation circuit 8, and the third drive waveform generation circuit 10 and the fourth drive waveform generation circuit 11, one of the drive waveforms is selected by an analog switch ASW, and piezoelectric elements (for example, piezoelectric elements 36 and 39 illustrated in FIG. 5) of the first and second droplet discharge devices 13 and 14 (for example, an inkjet head) are driven.

In the following description, the first drive waveform generation circuit 7 and the second drive waveform generation circuit 8, and the third drive waveform generation circuit 10 and the fourth drive waveform generation circuit 11 will be referred to as drive waveform generation circuits when not distinguished from each other. In FIG. 5, the droplet discharge device 30 represents a detailed configuration example of each of the first droplet discharge device 13 and the second droplet discharge device 14 illustrated in FIG. 4, a drive waveform generation circuit 31 corresponds to the first drive waveform generation circuit 7 or the third drive waveform generation circuit 10 illustrated in FIG. 4, and a drive waveform generation circuit 32 corresponds to the second drive waveform generation circuit 8 or the fourth drive waveform generation circuit 11 illustrated in FIG. 4.

However, if three or four or more drive waveform generation circuits and the analog switch ASW are prepared instead of two drive waveform generation circuits and the analog switch ASW for each nozzle ch included in the inkjet head, not two kinds of drive waveform generation circuits but more kinds of drive waveforms can be applied to each piezoelectric element, but in the present embodiment, a minimum configuration in which two drive waveform generation circuits and the analog switch ASW are used will be described.

Upon entering the appropriate Vj correction mode in response to a mode switching instruction from the upper control device 1, the Vj adjustment control circuit 4, the first waveform selection control circuit 9, the second waveform selection control circuit 12, and the droplet observation device (for example, a camera) 6 obtain a voltage value that satisfies the discharge of the droplet so as to suppress the variation in the discharge speed within a prescribed range for each inkjet head, each ch, and each drive frequency so as to suppress the decrease amount of the discharge speed in the central portion of the inkjet head. Then, the Vj adjustment control circuit 4 stores a voltage value map including the obtained voltage value on the memory 5.

Upon entering the normal drive mode in response to the mode switching instruction from the upper control device 1, the Vj adjustment control circuit 4 accesses the memory 5, reads the voltage value map stored in the appropriate Vj correction mode, gives an instruction to the first to fourth drive waveform generation circuits 7, 8, 10, and 11 with an appropriate voltage value, and discharges the droplets with an appropriate voltage value. The two drive waveform generation circuits are provided for each head so that the first drive waveform generation circuit 7 generates and outputs a drive waveform at a drive frequency at which the discharge speed does not decrease, and the second drive waveform generation circuit 8 can generate and output a corrected waveform (drive waveform with an increased voltage value) at a drive frequency at which the discharge speed decreases. By performing the generation and output of the corrected waveform, it is possible to reduce the decrease in the discharge speed of the central portion when the environmental temperature in the printing apparatus and the drive frequency that decreases with the type of ink to be used change for each inkjet head, and to improve the print quality.

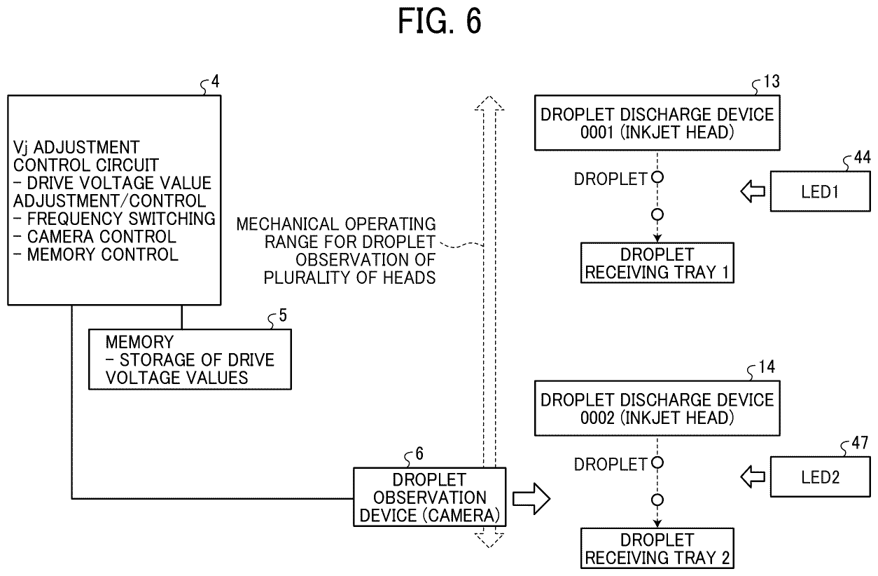

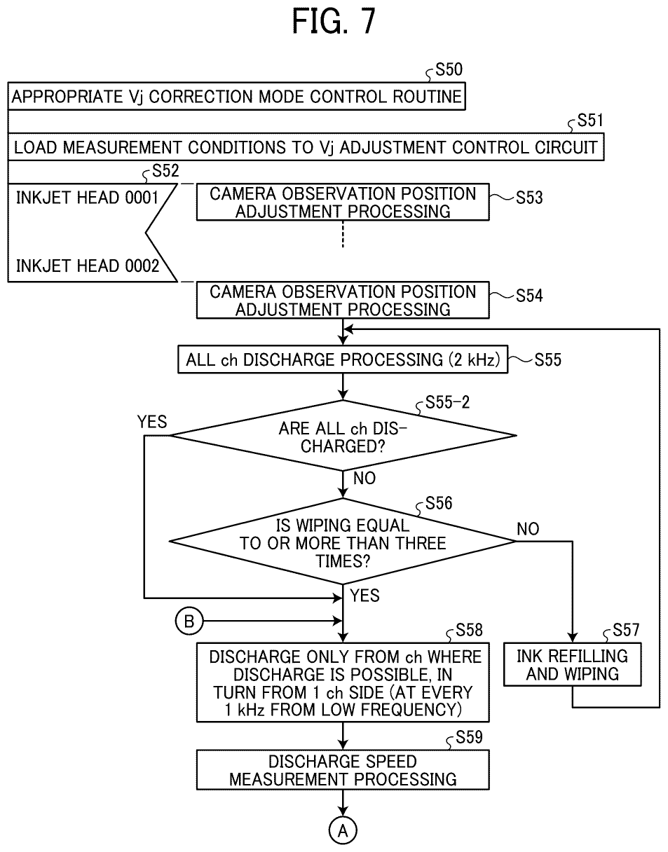

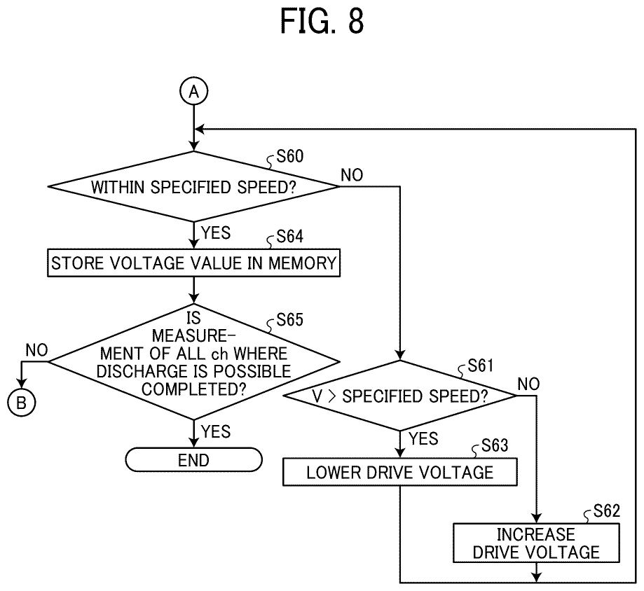

An example of a flow of measurement processing of the discharge speed of a droplet in the inkjet head control device according to the present embodiment will be described with reference to FIGS. 4 and 6 to 8. FIG. 6 is a diagram for describing an example of the measurement processing of the discharge speed of a droplet in the inkjet head control device according to the present embodiment. FIGS. 7 and 8 are flowcharts illustrating an example of a flow of the measurement processing of the discharge speed of a droplet in the inkjet head control device according to the present embodiment.

The Vj adjustment control circuit 4 transitions to the appropriate Vj correction mode according to the mode switching instruction from the upper control device 1. First, the upper control device 1 instructs the Vj adjustment control circuit 4 on measurement conditions. Here, the measurement conditions may be information such as a head number, a drive frequency (pinpoint drive frequency or range of drive frequencies), an ink type, a head temperature, and the like of the inkjet head for which it is desired to measure the discharge speed. In the present embodiment, the measurement conditions include a head number of 0002, a drive frequency (2 to 40 kHz, each 1 kHz), an ink type (for example, fixed), a head temperature (for example, fixed at 25° C.), and the like.

In step S51, the measurement conditions are loaded from the upper control device 1 to the Vj adjustment control circuit 40. In step S52, the Vj adjustment control circuit 4 determines that the inkjet head for which the discharge speed is measured on the basis of the measurement conditions as the head No. 0002, and the process proceeds to step S53. Next, in step S53, the Vj adjustment control circuit 4 performs camera observation position adjustment processing. In the camera observation position adjustment processing, the droplet observation device (camera) 6 mechanically moves to a position where the droplet of the second droplet discharge device 14 can be observed. Thereafter, a medium is removed, and then a second droplet receiving tray for receiving droplets is prepared. Here, since the droplet receiving tray is located at the same position as a normal medium, a method of mechanically moving the inkjet head to a position shifted from the medium and setting the inkjet head at a position where the droplet receiving tray is located may be used.

Next, the second light emitting diode (LED) 47 is turned ON, an image is acquired by the droplet observation device 6, a nozzle surface of the second droplet discharge device 14 is determined, and after the nozzle surface is determined, a distance (for example, 1 mm) corresponding to a medium gap in head specifications from the nozzle surface is prepared as a determination line by image processing. As the measurement of the discharge speed, it is possible to calculate the discharge speed based on how long the distance from the nozzle surface to 1 mm is reached. The second LED 47 is turned on or off in synchronization with the drive frequency, so that observation by the camera is facilitated.

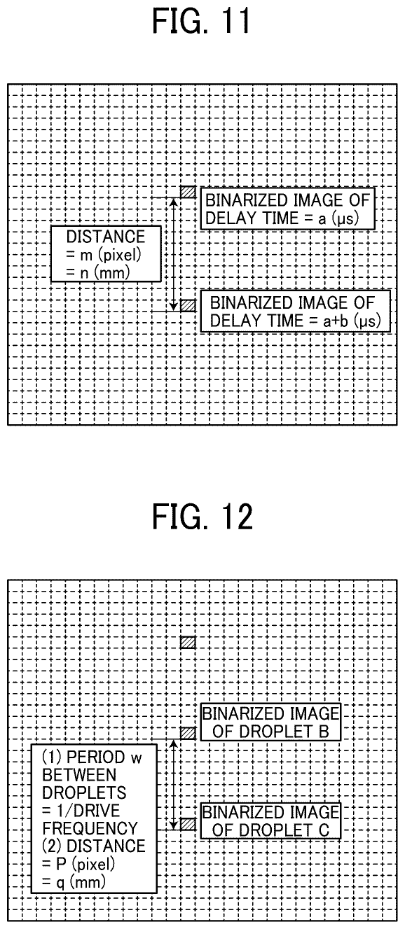

Delay time of the second LED 47 will be described using an example of a drive waveform in FIG. 11 to be described later. When the delay time is 0 us, the drive waveform remains at an intermediate potential at the timing of 0 us in FIG. 11. In the image of the camera at the delay time, the droplet cannot be confirmed on the nozzle surface yet. For example, the head may have a stacked piezo type configuration. At about 8 to 9 us in FIG. 11, a timing at which the droplet is visible on the nozzle surface comes. This time (this delay time) is defined as t1. On the other hand, when the delay time at which the droplet reaches a 1 mm line is t2, the discharge speed v1 is calculated by the following equation (1).

V1=1 mm/(t2−t1) (1)

In addition, the appropriate discharge speed varies in both the inkjet head (for example, a stacked piezo structure) and a specification difference of a liquid chamber configuration, but if the variation is within the range of #15 to 20%, the image quality is said to be comparable. In the present embodiment, when the discharge speed is within +20% from the reference speed, it is determined as OK (appropriate) and processing is performed.

Next, in step S54, the Vj adjustment control circuit 4 performs discharge processing from the nozzles of all ch. In the present embodiment, since the drive frequency can be selected according to the specifications, the drive frequency is set to 2 kHz, for example. The discharge processing is performed to check in advance whether droplets have been discharged from nozzles of all ch. In step S55, the Vj adjustment control circuit 4 checks whether droplets are discharged from the nozzles of all ch. When the droplets are not discharged from the nozzles of all ch (step S55: No), the Vj adjustment control circuit 4 proceeds to step S56 and checks whether the number of times of wiping is equal to or more than three.

When the number of times of wiping is less than three times (step S56: No), the Vj adjustment control circuit 4 proceeds to step S57, refills the ink, performs wiping, and adjusts the meniscus of the nozzle of each ch. Thereafter, the process returns to step S55. When the droplets are discharged from the nozzles of all ch (step S55: Yes) and when the number of times of wiping is equal to or more than three times (step S56: Yes), the process proceeds to step S58, and the Vj adjustment control circuit 4 discharges the droplets only from the nozzles of the ch where discharge of droplet is possible, in turn from the 1 ch side. At that time, the drive frequency can be adjusted at each one kHz from a low frequency (for example, 2 kHz). For example, the Vj adjustment control circuit 4 first discharges a droplet at a drive frequency of 2 kHz from the nozzle of 1 ch. Next, in step S59, the Vj adjustment control circuit 4 measures the discharge speed of the droplet. Details of the processing of measuring the discharge speed of the droplet will be described later.

Next, in step S60, the Vj adjustment control circuit 4 determines whether or not the measured discharge speed is within a specified speed. When the measured discharge speed is within the specified speed (step S60: Yes), the Vj adjustment control circuit 4 stores the voltage value in the memory 5 in step S64. On the other hand, when the measured discharge speed is not within the specified speed (step S60: No), the Vj adjustment control circuit 4 proceeds to step S61 and determines whether or not the measured discharge speed is higher than the specified speed. When the measured discharge speed is higher than the specified speed (step S61: Yes), the Vj adjustment control circuit 4 proceeds to step S63 to lower the drive voltage. The step voltage for lowering the drive voltage depends on the head specifications, but may be, for example, about 0.1 to 0.2 V. When the measured discharge speed is equal to or lower than the specified speed (step S61: No), the Vj adjustment control circuit 4 proceeds to step S62 and increases the drive voltage.

After the process in steps S62 and S63 is performed, the process returns to step S60. After the process in step S64 is performed, the Vj adjustment control circuit 4 proceeds to step S65 and determines whether the measurement of the discharge speed has been completed for the nozzles of all ch where discharge is possible. When the measurement of the discharge speeds has not been completed for the nozzles of all ch where discharge is possible (step S65: No), the process returns to step S58, and when the measurement of the discharge speed has been completed for the nozzles of all ch where discharge is possible (step S65: Yes), the measurement of the discharge speeds is terminated.

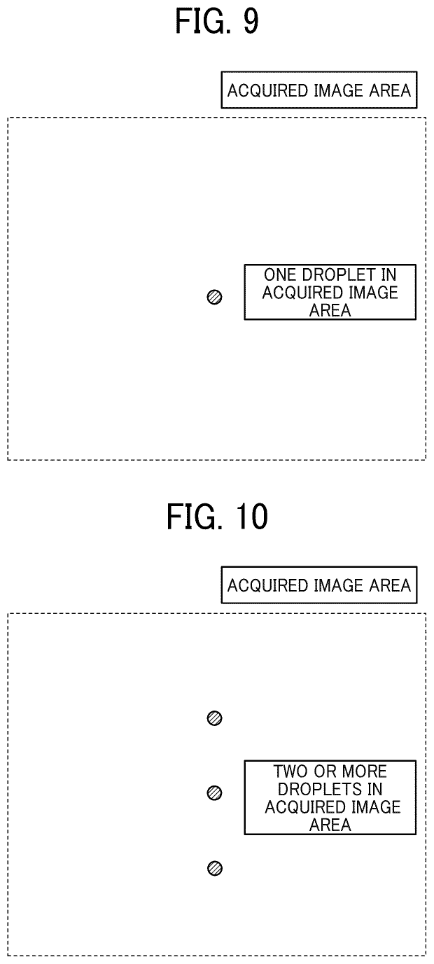

Next, an example of details of the method of measuring the discharge speed in step S59 of FIG. 7 will be described with reference to FIGS. 9 to 12. FIGS. 9 to 12 is a diagram for describing an example of measurement processing of the discharge speed in the liquid discharge apparatus according to the present embodiment.

In the present embodiment, the Vj adjustment control circuit 4 measures the discharge speed using the droplet observation device 6. There are two patterns of droplet states of droplets discharged from the nozzle illustrated in FIGS. 9 and 10. One pattern is when there is a drop in the acquired image. Another pattern is when two or more drops are present in the acquired image. In the case of automatically measuring the discharge speed of the droplets, the Vj adjustment control circuit 4 binarizes the acquired image. By binarizing the image, the distance between the droplets can be calculated with the area of the droplets in the image area as 1 and the other area as 0.

First, as illustrated in FIG. 11, a method of measuring the discharge speed in a case where there is one droplet in the acquired image will be described. The droplet observation device 6 acquires an image at the delay time a (μs). Next, the droplet observation device 6 acquires an image at the delay time a+b (μs). Then, the droplet observation device 6 overwrites the previously acquired image (the former image) with the image acquired later by or processing. As a result, the droplet observation device 6 can calculate the distance n (mm) between the droplets at two points on the basis of the pixel value=m of the droplets at the two points in the image, and thus, can obtain the discharge speed v1 of the droplet=n (mm)/b (μs).

Next, as illustrated in FIG. 12, a method of measuring the discharge speed in a case where there are two or more droplets in the acquired image will be described. For example, the droplet observation device 6 calculates the discharge speed for the lower two droplets existing in the acquired image. As illustrated in FIG. 12, the period w between the droplets B and C is w=1/drive frequency. The distance between the droplet B and the droplet Cis q (mm) on the basis of the pixel value=p of the two points. As a result, the droplet observation device 6 can obtain the discharge speed by v2=q (mm)/w (μs).

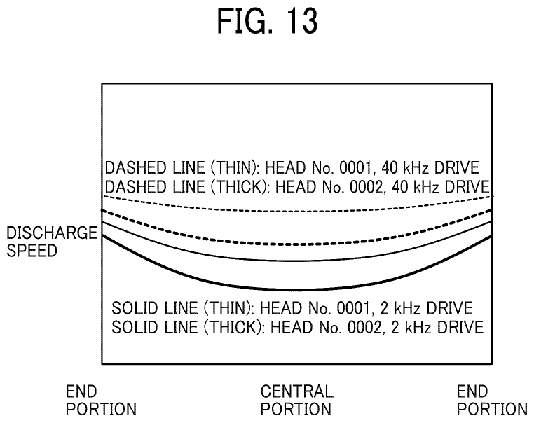

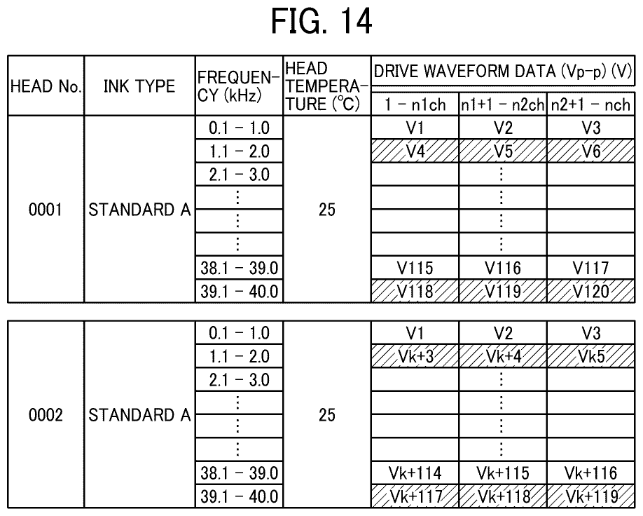

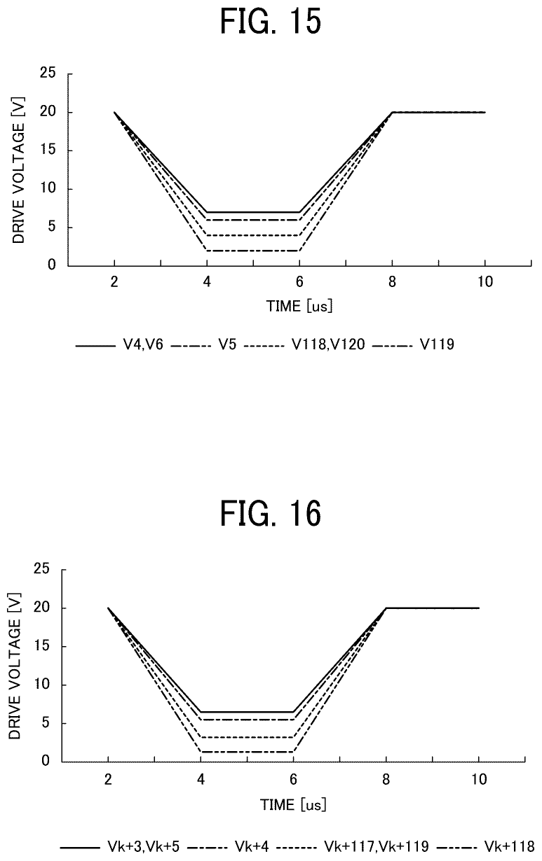

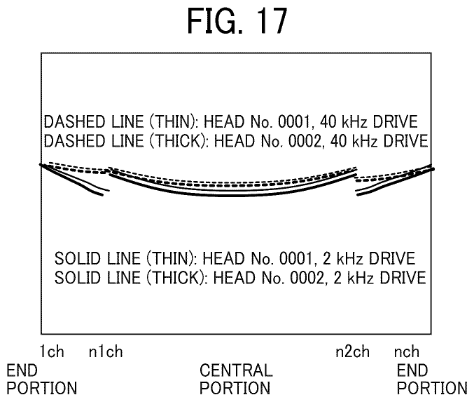

FIG. 13 is a diagram illustrating an example of the discharge speed when inkjet heads (Nos. 0001 and 0002) are driven with a constant drive waveform in the inkjet head control device according to the present embodiment. FIG. 14 is a diagram illustrating an example of a voltage value map of a drive waveform for correcting the inkjet head in the inkjet head control device according to the present embodiment. FIG. 15 is a diagram illustrating an example of a drive waveform of an inkjet head (No. 0001) in the inkjet head control device according to the present embodiment. FIG. 16 is a diagram illustrating an example of a drive waveform of an inkjet head (No. 0002) in the inkjet head control device according to the present embodiment. FIG. 17 is a diagram illustrating an example of a corrected discharge speed in the inkjet head control device according to the present embodiment.

When the voltage value of the drive waveform is not corrected, as illustrated in FIG. 13, the end portion of the inkjet head has the frequency characteristics illustrated in FIGS. 1 and 2. The discharge speed of the central portion of the inkjet head becomes lower than that of the end portion due to the influence of a voltage drop in a piezo feed line, and the like. The voltage value map illustrated in FIG. 14 is a voltage value map in which the discharge speed in the inkjet head illustrated in FIG. 13 is adjusted to fall within a discharge speed range defined by the inkjet head in the configuration of the inkjet head control device 2 illustrated in FIG. 4. In the present embodiment, the voltage value map indicates a voltage value for each drive frequency and for each ch at a certain ink type and head temperature. Regarding the ch of the nozzle, the nozzle of the ch to be driven is divided into three, and the voltage (p-p) of the drive waveform is described for each drive frequency of 1 kHz. Supplementing the voltage value map illustrated in FIG. 14, an example is illustrated of a voltage value map illustrating three types of voltage values of an end portion (1 to n1 ch), an end portion (n2+1 to n ch), and a central portion (n1+1 to n2 ch) at each drive frequency (the highest drive frequency in the head specifications at each 1 kHz) for each head No, ink type, and head temperature.

Although depending on the characteristics of the inkjet head, there is a tendency that the discharge speed of the nozzle of ch in the central portion is slow and the voltage value is high, and the discharge speed of the nozzle of ch in the end portion is faster and the voltage value is lower than that of the nozzle of ch in the central portion. Therefore, it is possible to use two types of voltage values of the end portion and the central portion while setting the decrease in the discharge speed of the nozzle of ch in the central portion and the voltage values of the end portion (for example, 1 to n1 ch) and the end portion (for example, n2+1 to n ch) to be the same.

For example, when the drive waveform generation circuit and the analog switch ASW illustrated in FIGS. 4 and 5 are increased to three for each ch, the three types of voltage values illustrated in FIG. 14 corresponding to the number of the drive waveform generation circuit and the analog switch ASW can be selected and set. In the present embodiment, for the sake of description, a minimum configuration including two types of drive waveform generation circuits and analog switch ASW for each ch is described as an example.

The waveform selection control circuit 33 illustrated in FIG. 5 sets the voltage values (the voltage values of 1 to n1 ch and the voltage values of n2+1 to n ch) of the end portion of the head in FIG. 14 to the same voltage value and sets two types of drive voltages of the voltage value of the central portion (n1+1 to n2 ch) and the voltage value of the end portion in order to switch the two types of drive waveforms. FIGS. 15 and 16 are examples of the drive waveform, and are created from data of an example of a drive waveform data table of FIG. 14. In this example, the drive waveform is generated so that Vp-p of the drive voltage increases in ascending order of the discharge speed illustrated in FIG. 13. By driving using a plurality of voltages obtained by correcting a drive voltage at each head number and each drive frequency, the change in the discharge speed can be reduced as in the corrected discharge speed example illustrated in FIG. 17, and the print quality can be improved.

Here, an example of a method of setting the drive voltage in the normal drive mode will be described with reference to FIGS. 4, 5, and 14.

First, in step S1, the print operation menu is transmitted from the upper control device 1 to the inkjet head control device 2. Here, in the first and second liquid discharge apparatuses 13 and 14, the print operation menu indicates an operation of performing printing of k lines at a drive frequency of 2 kHz, and an operation of performing printing of m lines at a drive frequency of 40 kHz. The print operation menu is read by the Vj adjustment control circuit 4.

Next, in step S2, when the first droplet discharge device 13 is driven at a drive frequency of 2 kHz, V4 (=V6) is set to the first drive waveform generation circuit 7 for the end portion of the first droplet discharge device 13, and V5 is set to the second drive waveform generation circuit 8 for the central portion of the first droplet discharge device 13. Here, V4 (=V6) is a voltage value of the nozzles of 1 to n1 ch and the nozzles of n2+1 to n ch (end portions) of the first droplet discharge device 13. Further, V5 is a voltage value of a nozzle (central portion) of n1+1 to n2 ch included in the inkjet head.

In step S2, when the second droplet discharge device 14 is driven at a drive frequency of 2 kHz, Vk+3 (=Vk+6) is set to the third drive waveform generation circuit 10 for the end portion of the second droplet discharge device 14, and Vk+4 is set to the fourth drive waveform generation circuit 11 for the central portion of the second droplet discharge device 14. Here, Vk+3 (=Vk+5) is a voltage value of the nozzles of 1 to n1 ch and the nozzles (end portions) of n2+1 to n ch included in the second droplet discharge device 14. Further, Vk+4 is a voltage value of a nozzle (central portion) of n1+1 to n2 ch included in the second droplet discharge device 14.

In step S3, when k lines are printed by the droplet discharge device 30 at a drive frequency of 2 kHz, describing by referring to FIG. 5, the analog switch ASW connected to the first drive waveform generation circuit 31 is turned on by the waveform selection control circuit 33 at the end portion (nozzles of 1 to n1 ch and nozzles of n2+1 to n ch) of the droplet discharge device 30, and the drive waveform generated by the first drive waveform generation circuit 31 is applied to the piezoelectric element. In the nozzles of the central portion (n+1 to n2 ch) of the droplet discharge device 30, the analog switch ASW connected to the drive waveform generation circuit 32 is turned on by the waveform selection control circuit 33, and the drive waveform generated by the second drive waveform generation circuit 32 is applied to the piezoelectric element.

In step S4, when the nozzles included in the first droplet discharge device 13 are driven at a drive frequency of 40 kHz, V118 (=V120) is set to the first drive waveform generation circuit 7 (for the end portion), and V119 is set to the second drive waveform generation circuit 8 (for the central portion). When the nozzles included in the second droplet discharge device 14 are driven at a drive frequency of 40 kHz, Vk+117 (Vk+119) is set to the third drive waveform generation circuit 10 (for the end portion), and Vk+118 is set to the fourth drive waveform generation circuit 11 (for the central portion). Here, V118 is a voltage value of nozzles of 1 to n1 ch and n2+1 to n ch which are end portions of the first droplet discharge device 13, and V119 is a voltage value of n1+1 to n2 ch which are central portions of the first droplet discharge device 13. Here, Vk+117 is a voltage value of 1 to n1 ch and n2+1 to n ch which are end portions of the second droplet discharge device 14, and Vk+118 is a voltage value of n1+1 to n2 ch which are central portions of the second droplet discharge device 14.

In step S5, when the m-line is printed by the first and second droplet discharge devices 13 and 14 at a drive frequency of 40 kHz, a drive waveform is applied to the piezoelectric element as in step S3.

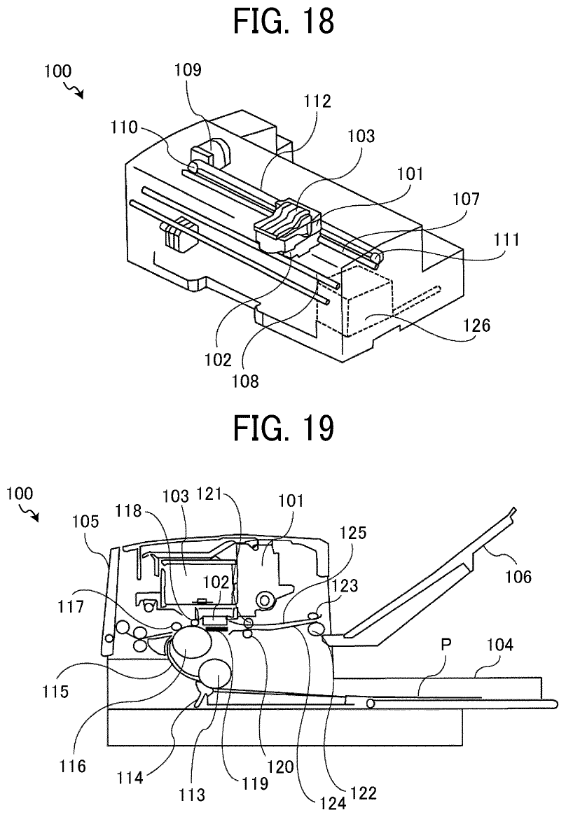

FIGS. 18 and 19 are views schematically illustrating an example of an overall configuration of an inkjet printer which is an example of a liquid discharge apparatus according to the present embodiment. Specifically, FIG. 18 is a see-through perspective view of an inkjet printer 100, and FIG. 19 is a see-through side view of the inkjet printer 100.

As illustrated in FIGS. 18 and 19, the inkjet printer 100 (an example of a liquid discharge apparatus or an image forming apparatus) according to the present embodiment includes a carriage 101 that is movable in the main scanning direction inside an apparatus main body, a recording head 102 (droplet discharge devices 13 and 14 such as inkjet heads) mounted on the carriage 101, a printing mechanism unit including ink cartridges 103 that supply ink to the recording head 102, and the like. To the lower portion of the apparatus main body of the inkjet printer 100, a sheet feeding cassette (or sheet feeding tray) 104 in which recording media such as a large number of sheets P can be loaded from the front side can be detachably attached. In the inkjet printer 100, the manual sheet feeding tray 105 for manually feeding the sheet P can be opened.

The inkjet printer 100 takes in the sheet P fed from the sheet feeding cassette 104 or the manual sheet feeding tray 105, records a necessary image by the above-described printing mechanism unit, and then discharges the sheet P to the sheet ejection tray 106 attached to the rear surface side. Note that, hereinafter, a case where the recording medium is a sheet P will be described as an example, but the recording medium may be a sheet material such as a film or plastic in addition to the sheet, and any recording medium can be employed as long as it is an object of image formation output.

In the printing mechanism unit, the carriage 101 is slidably held in the main scanning direction (the direction perpendicular to the paper surface) by the main guide rod 107 and the sub-guide rod 108 which are guide members laterally bridged on the left and right side plates. A liquid discharge unit 440 in which the recording head 102 and the head tank 441 are integrated is mounted on the carriage 101. The recording head 102 mounted on the liquid discharge unit 440 discharges ink droplets of respective colors of yellow, cyan, magenta, and black. The plurality of ink discharge ports that ejects the ink of each color are arranged in a direction (sub-scanning direction) intersecting the main scanning direction, and the ink discharge ports are directed downward.

Each ink cartridge 103 for supplying the ink of each color to the recording head 102 is replaceably mounted in the carriage 101. The ink cartridge 103 has an atmosphere port communicating with the atmosphere on the upper side, a supply port for supplying ink to the recording head 102 on the lower side, and a porous body filled with ink therein. Due to capillary force of the porous body, the ink supplied to the recording head 102 is maintained at a slight negative pressure. In the present embodiment, the case where the recording head 102 is provided for each color is taken as an example, but one head having a nozzle that discharges ink of each color may be used.

The carriage 101 has a rear side (downstream side in the sheet conveyance direction) slidably attached to the main guide rod 107, and a front side (upstream side in the sheet conveyance direction) slidably attached to the sub-guide rod 108. In order to move and scan the carriage 101 in the main scanning direction, a timing belt 112 is stretched between a driving pulley 110 and a driven pulley 111 that are rotationally driven by a main scanning motor 109. The timing belt 112 and the carriage 101 are secured, and the carriage 101 is reciprocated by forward and reverse rotation of the main scanning motor 109.

On the other hand, in order to convey the sheet set in the sheet feeding cassette 104 to the lower side of the recording head 102, a sheet feeding roller 113, a friction pad 114, a guide member 115, a conveyance roller 116, a conveyance runner 117, and a leading end runner 118 are provided. The sheet feeding roller 113 and the friction pad 114 separate and feed the sheet P from the sheet feeding cassette 104, and the guide member 115 guides the separated and fed sheet P.

The conveyance roller 116 reverses and conveys the fed sheet P. The conveyance runner 117 is pressed against the peripheral surface of the conveyance roller 116, and the leading end runner 118 defines a feeding angle of the sheet P from the conveyance roller. The conveyance roller 116 is rotationally driven by a sub-scanning motor via a gear train.

A print receiving member 119, which is a sheet guide member that guides the sheet P fed from the conveyance roller 116 on the lower side of the recording head 102 corresponding to the movement range of the carriage 101 in the main scanning direction, is provided. On the downstream side in the sheet conveyance direction of the print receiving member 119, a conveyance runner 120 and a spur 121 that are rotationally driven are provided to send out the sheet P in the sheet ejection direction. Further, a sheet ejection roller 122 and a spur 123 for feeding the sheet P to the sheet ejection tray 106, and guide members 124 and 125 forming a sheet ejection path are disposed.

At the time of image recording on the sheet P, the controller of the inkjet printer 100 drives the recording head 102 according to an image signal while moving the carriage 101, thereby discharging ink onto the stopped sheet P and recording the amount of one scan. Then, the controller of the inkjet printer 100 performs recording of the next row after conveying the sheet P by a predetermined amount. Upon receiving a recording end signal or a signal indicating that the rear end of the sheet P has reached the recording area, the controller of the inkjet printer 100 terminates the recording operation and ejects the sheet P.

The recording head 102 includes a piezoelectric element as a drive element for driving each of the plurality of nozzles provided as described above. That is, in the inkjet printer 100 according to the present embodiment, a piezoelectric element is used as an actuator element that generates a discharge force for discharging ink (an example of droplets) from each of the plurality of nozzles. By applying a predetermined drive waveform to the piezoelectric element, ink is discharged from each nozzle. That is, the recording head 102 (an example of a liquid discharge head) includes a plurality of nozzles, and a piezoelectric element (piezo) that is provided for each of the nozzles and that discharges ink from the nozzles when a drive signal (drive waveform) is applied.

At a position outside the recording area on the right end side in the moving direction of the carriage 101, a maintenance and recovery device 126 for recovering discharge failure of the recording head 102 is disposed. The maintenance and recovery device 126 includes a cap unit, a suction unit, and a cleaning unit. The carriage 101 is moved to the maintenance and recovery device 126 side during printing standby, and the recording head 102 is capped by a capping unit. As a result, the discharge orifice portion is maintained in a wet state, and discharge failure due to ink drying is prevented.

The recording head 102 discharges (dummy-discharge) ink not related to recording to the maintenance and recovery device 126 in the middle of recording or the like, thereby making the ink viscosity of all the discharge ports constant and maintaining stable discharge performance. Specifically, when a discharge failure occurs, for example, the capping unit seals the discharge port (nozzle) of the recording head 102, and the suction unit sucks air bubbles and the like together with the ink from the discharge port through the tube. Ink, dust, and the like adhering to the discharge orifice surface are removed by the cleaning unit, and discharge failure is recovered. The sucked ink is discharged to a waste ink container disposed on a lower portion of a device body, and is absorbed into and retained in an ink absorber in the waste ink container.

For the liquid discharge head such as the recording head 102, a pressure generator used is not limited. For example, in addition to the piezoelectric actuator (which may use a stacked piezoelectric element) described in the above embodiment, a thermal actuator using an electrothermal transducer such as a heating resistor, an electrostatic actuator including a diaphragm and a counter electrode, or the like may be used.

The terms “image formation”, “recording”, “printing”, “image printing”, and “fabricating” used herein may be used synonymously with each other.

In the present embodiment, the liquid discharge unit is formed by integrating a functional component and a mechanism with a liquid discharge head, and is an assembly of components related to liquid discharge. For example, the liquid discharge unit 440 includes a combination of the recording head 102 and at least one of a head tank such as the ink cartridge 103, a carriage 101, a supply mechanism, the maintenance and recovery device 126, and a main scanning movement mechanism.

Here, examples of the integrated unit include a combination in which the liquid discharge head and a functional part(s) are secured to each other through, e.g., fastening, bonding, or engaging, and a combination in which one of the liquid discharge head and a functional part(s) is movably held by another. The liquid discharge head may be detachably attached to the functional component(s) or unit(s) each other.

For example, the liquid discharge head and a head tank are integrated as the liquid discharge device. The liquid discharge head and the head tank may be integrated by being coupled with each other via a tube or the like. Here, a unit including a filter may further be added to a portion between the head tank and the liquid discharge head.

As the liquid ejection unit, there is a device in which the liquid ejection head and the carriage 101 are integrated.

As the liquid discharge unit, there is a device in which the liquid discharge head is movably held by a guide member constituting a part of the main scanning movement mechanism, and the liquid discharge head and the main scanning movement mechanism are integrated. The liquid discharge head, the carriage 101, and the main scanning movement mechanism may be integrated.

As the liquid discharge unit, there is a device in which a cap member which is a part of the maintenance and recovery device 126 is secured to the carriage 101 to which the liquid discharge head is attached, and the liquid discharge head, the carriage 101, and the maintenance and recovery device 126 are integrated.

In another example, the liquid discharge device includes tubes connected to the head tank or the channel member mounted on the liquid discharge head so that the liquid discharge head and the supply assembly are integrated as a single unit. Liquid is supplied from a liquid reservoir source to the liquid discharge head.

The main scanning movement mechanism may be a single guide. The supply unit may be a single tube or a single loading unit.

In the present application, a liquid discharge apparatus such as the inkjet printer 100 is an apparatus that includes a liquid discharge head or a liquid discharge unit and drives the liquid discharge head to discharge liquid. The liquid discharge apparatus includes not only an apparatus capable of discharging liquid to an object to which liquid can adhere but also an apparatus that discharges liquid toward air or liquid.

The liquid discharge apparatus may include a unit related to feeding, conveyance, and sheet ejection of a liquid adherable material, a preprocessing device, a post-processing device, and the like.

Examples of the liquid discharge apparatus include an image forming apparatus that discharges ink to form an image on a sheet, and a three-dimensional fabricating device that discharges fabrication liquid to a powder layer in which powder is formed into a layer in order to fabricate a three-dimensional fabrication object.

The liquid discharge apparatus is not limited to a device that visualizes a meaningful image such as a character or a figure by the discharged liquid. For example, a device that forms a meaningless pattern, or a device that fabricates a three-dimensional image are also included.

The object to which the liquid can adhere means an object to which the liquid can at least temporarily adhere, an object to which the liquid adheres and is fixed, an object to which the liquid adheres and permeates, and the like. As detailed examples, the material may be a medium including a recording medium such as paper, a recording sheet, recording paper, a film, cloth, and the like, an electronic part such as an electronic substrate, a piezoelectric element, and the like, a powder material layer (powder layer), an organ model, an inspection cell, and the like, and any liquid adherable material can be included unless a specific limitation is applied.

The material to which the liquid can adhere may be any material as long as the liquid can adhere even temporarily, such as paper, thread, fiber, cloth, leather, metal, plastic, glass, wood, or ceramics.

The liquid is not particularly limited as long as the liquid has viscosity or surface tension with which the liquid can be discharged from the liquid discharge head, but the viscosity is preferably 30 mPa·s or less at normal temperature and normal pressure, or by heating or cooling. More specifically, examples thereof include solutions, suspensions, emulsions, and the like containing solvents such as water and organic solvents, colorants such as dyes and pigments, functionalizing materials such as polymerizable compounds, resins, and surfactants, biocompatible materials such as deoxyribonucleic acid (DNA), amino acids, proteins, and calcium, edible materials such as natural pigments, and the like, and these can be used for, for example, inkjet inks, surface treatment liquids, liquids for forming components of electronic elements and light emitting elements and electronic circuit resist patterns, material liquids for three-dimensional modeling, and the like.

Further, the liquid discharge apparatus includes a device in which the liquid discharge head and the material to which the liquid can adhere move relative to each other, but is not limited thereto. Specific examples include a serial-type apparatus which moves the liquid discharge head, and a line type apparatus which does not move the liquid discharge head.

Other examples of the liquid discharge apparatus include a treatment liquid application apparatus that discharges a treatment liquid onto a sheet in order to apply the treatment liquid to the surface of the sheet for the purpose of modifying the surface of the sheet, and an injection granulation apparatus that injects a composition liquid in which a raw material is dispersed in a solution through a nozzle to granulate fine particles of the raw material.

As described above, with the liquid discharge apparatus according to the present embodiment, it is possible to reduce a difference in discharge speed between the central portion and the end portion of the row of nozzles including a change in the drive frequency of the nozzles included in the liquid discharge head, a variation between the liquid discharge heads, an environmental temperature in the printing apparatus, and a variation in the type of ink to be used, so that the print quality can be improved.

The program executed by the liquid discharge apparatus of the present embodiment is provided by being incorporated in a read-only memory (ROM) or the like in advance. The program executed by the liquid discharge apparatus of the present embodiment may be provided by being recorded in a computer-readable recording medium such as a compact disc read only memory (CD-ROM), a flexible disk (FD), a compact disc recordable (CD-R), or a digital versatile disc (DVD) as a file in an installable format or an executable format.

Furthermore, the program executed by the liquid discharge apparatus of the present embodiment may be stored on a computer connected to a network such as the Internet and provided by being downloaded via the network. The program executed by the liquid discharge apparatus of the present embodiment may be provided or distributed via a network such as the Internet.

The program executed by the liquid discharge apparatus of the present embodiment has a module configuration including the above-described respective units (drive signal output unit, voltage information acquisition unit, and controller), and as actual hardware, an example of a processor such as a central processing unit (CPU) reads the program from the ROM and executes the program, whereby the respective units are loaded onto a main storage device, and a drive signal output unit, a voltage information acquisition unit, and a controller are generated on the main storage device.

Aspects of the present disclosure are, for example, as follows.

### First Aspect

According to a first aspect, a liquid-discharge-head driving device for driving a liquid discharge head that includes a plurality of nozzles to discharge liquid according to an input drive signal includes: a drive signal output unit to generate the drive signal based on voltage information on a voltage applied to a piezoelectric element of the nozzles and output the drive signal to the liquid discharge head; a voltage information acquisition unit to acquire, based on droplet speed information acquired from a droplet speed measuring unit that measures a discharge speed of a droplet discharged from the liquid discharge head and the voltage information, appropriate voltage information on a voltage at which the discharge speed falls within a predetermined range; a storage unit to store the appropriate voltage information in association with identification information of the nozzles and a drive frequency of the nozzles; and a controller to acquire, from the storage unit, the appropriate voltage information corresponding to the identification information and the drive frequency and cause the drive signal output unit to output the drive signal based on the appropriate voltage information.

### Second Aspect

According to a second aspect, the liquid-discharge-head driving device of the first aspect further includes the droplet speed measuring unit. The droplet speed measuring unit includes a camera that measures the droplet, and the camera is movable with respect to the liquid discharge head and is capable of measuring the discharge speed for each of the nozzles.

### Third Aspect

According to a third aspect, the liquid-discharge-head driving device of the first or second aspect has a normal drive mode and a correction mode, and the voltage information acquisition unit acquires the appropriate voltage information, based on the droplet speed information and the voltage information, in response to transition to the correction mode.

### Fourth Aspect

According to a fourth aspect, in the liquid-discharge-head driving device of any one of the first to third aspects, the liquid discharge head includes a plurality of liquid discharge heads, and the voltage information acquisition unit acquires the appropriate voltage information for each of the liquid discharge heads.

### Fifth Aspect

According to a fifth aspect, in the liquid-discharge-head driving device of any one of the first to fourth aspects, the voltage information acquisition unit acquires the appropriate voltage information for each of temperatures around the liquid discharge head.

### Sixth Aspect

According to a sixth aspect, in the liquid-discharge-head driving device of any one of the first to fifth aspects, the voltage information acquisition unit acquires the appropriate voltage information for each type of ink discharged from the liquid discharge head.

### Seventh Aspect

According to a seventh aspect, a liquid-discharge-head driving system includes: a liquid-discharge-head driving device for driving a liquid discharge head that includes a plurality of nozzles to discharge liquid according to an input drive signal; and a droplet speed measuring unit including a camera that is movable with respect to the liquid discharge head and capable of measuring a discharge speed of liquid for each of the nozzles of the liquid discharge head. The liquid-discharge-head driving device includes: a drive signal output unit to generate the drive signal based on voltage information on a voltage applied to a piezoelectric element of the nozzles and output the drive signal to the liquid discharge head; a voltage information acquisition unit to acquire, based on droplet speed information acquired from the droplet speed measuring unit that measures a discharge speed of a droplet discharged from the liquid discharge head and the voltage information, appropriate voltage information on a voltage at which the discharge speed falls within a predetermined range; a storage unit to store the appropriate voltage information in association with identification information of the nozzles and a drive frequency of the nozzles; and a controller to acquire, from the storage unit, the appropriate voltage information corresponding to the identification information and the drive frequency and cause the drive signal output unit to output the drive signal based on the appropriate voltage information. The droplet speed measuring unit is to communicate with the liquid-discharge-head driving device.

### Eighth Aspect

According to an eighth aspect, a liquid discharge apparatus includes: a liquid discharge head including a plurality of nozzles to discharge liquid according to an input drive signal; a drive signal output unit to generate the drive signal based on voltage information on a voltage applied to a piezoelectric element of the nozzles and output the drive signal to the liquid discharge head; a voltage information acquisition unit to acquire, based on droplet speed information acquired from a droplet speed measuring unit that measures a discharge speed of a droplet discharged from the liquid discharge head and the voltage information, appropriate voltage information on a voltage at which the discharge speed falls within a predetermined range; a storage unit to store the appropriate voltage information in association with identification information of the nozzles and a drive frequency of the nozzles; and a controller to acquire, from the storage unit, the appropriate voltage information corresponding to the identification information and the drive frequency and cause the drive signal output unit to output the drive signal based on the appropriate voltage information.

### Ninth Aspect

According to a ninth aspect, a liquid-discharge-head driving method to be executed by a liquid-discharge-head driving device that drives a liquid discharge head including a plurality of nozzles to discharge liquid according to an input drive signal includes: generating the drive signal based on voltage information on a voltage applied to a piezoelectric element of the nozzles and outputting the drive signal to the liquid discharge head; acquiring, based on speed information acquired from a droplet speed measuring unit that measures a discharge speed of a droplet discharged from the liquid discharge head and the voltage information, appropriate voltage information on a voltage at which the discharge speed falls within a predetermined range; and acquiring, from a storage unit that stores the appropriate voltage information in association with identification information of the nozzles and a drive frequency of the nozzles, the appropriate voltage information corresponding to the identification information and the drive frequency and outputting the drive signal based on the appropriate voltage information.

### Tenth Aspect

According to a tenth aspect, a program causes a computer to function as: a drive signal output unit to generate, based on voltage information on a voltage applied to a piezoelectric element of nozzles included in a liquid discharge head that discharges liquid according to an input drive signal, the drive signal and outputs the drive signal to the liquid discharge head; a voltage information acquisition unit to acquire, based on droplet speed information acquired from a droplet speed measuring unit that measures a discharge speed of a droplet discharged from the liquid discharge head and the voltage information, appropriate voltage information of a voltage at which the discharge speed falls within a predetermined range; and a controller to acquire, from a storage unit that stores the appropriate voltage information in association with identification information of the nozzles and a drive frequency of the nozzles, the appropriate voltage information corresponding to the identification information and the drive frequency and cause the drive signal output unit to output the drive signal based on the appropriate voltage information.

Embodiments of the present disclosure are not limited to the above-described embodiments, and numerous additional modifications and variations are possible in light of the teachings within the technical scope of the present disclosure. It is therefore to be understood that the above-described embodiments of the present disclosure may be practiced otherwise by those skilled in the art than as specifically described herein. Such modifications are included in the technical scope described in the scope of claims. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A liquid-discharge-head driving device for driving a liquid discharge head including a plurality of nozzles to discharge liquid according to a drive signal input to the liquid discharge head, the liquid-discharge-head driving device comprising:
processing circuitry configured to:
generate the drive signal based on voltage information on a voltage applied to a piezoelectric element of the nozzles and output the drive signal to the liquid discharge head; and
acquire, based on droplet speed information acquired from a droplet speed measuring device that measures a discharge speed of a droplet discharged from the liquid discharge head and the voltage information, appropriate voltage information on a voltage at which the discharge speed falls within a predetermined range; and
a memory to store the appropriate voltage information in association with identification information of the nozzles and a drive frequency of the nozzles,
the processing circuitry configured to acquire, from the memory, the appropriate voltage information corresponding to the identification information and the drive frequency and output the drive signal based on the appropriate voltage information.

2. The liquid-discharge-head driving device according to claim 1, further comprising the droplet speed measuring device,
wherein the droplet speed measuring device includes a camera movable with respect to the liquid discharge head to measure the discharge speed of the droplet for each of the nozzles.

3. The liquid-discharge-head driving device according to claim 1,
wherein the liquid-discharge-head driving device has a normal drive mode and a correction mode, and
the processing circuitry is configured to acquire the appropriate voltage information, based on the droplet speed information and the voltage information, in response to transition to the correction mode.

4. The liquid-discharge-head driving device according to claim 1,
wherein the liquid discharge head includes a plurality of liquid discharge heads including the liquid discharge head, and the processing circuitry is configured to acquire the appropriate voltage information for each of the plurality of liquid discharge heads.

5. The liquid-discharge-head driving device according to claim 1,
wherein the processing circuitry is configured to acquire the appropriate voltage information for each of temperatures around the liquid discharge head.

6. The liquid-discharge-head driving device according to claim 1,
wherein the processing circuitry is configured to acquire the appropriate voltage information for each type of ink discharged from the liquid discharge head.

7. A liquid-discharge-head driving system, comprising:
the liquid-discharge-head driving device according to claim 1; and
a droplet speed measuring device to communicate with the liquid-discharge-head driving device,
wherein the droplet speed measuring device includes a camera to move with respect to the liquid discharge head and measure a discharge speed of liquid for each of the nozzles of the liquid discharge head.

8. A liquid discharge apparatus, comprising:
the liquid discharge head to discharge liquid according to the drive signal input to the liquid discharge head; and
the liquid-discharge-head driving device according to claim 1 to drive the liquid discharge head.

9. A liquid-discharge-head driving method to be executed by a liquid-discharge-head driving device that drives a liquid discharge head including a plurality of nozzles to discharge liquid according to a drive signal input to the liquid discharge head, the liquid-discharge-head driving method comprising:
generating the drive signal based on voltage information on a voltage applied to a piezoelectric element of the nozzles and outputting the drive signal to the liquid discharge head;
acquiring, based on droplet speed information acquired from a droplet speed measuring device that measures a discharge speed of a droplet discharged from the liquid discharge head and the voltage information, appropriate voltage information on a voltage at which the discharge speed falls within a predetermined range; and
acquiring, from a memory that stores the appropriate voltage information in association with identification information of the nozzles and a drive frequency of the nozzles, the appropriate voltage information corresponding to the identification information and the drive frequency and outputting the drive signal based on the appropriate voltage information.

10. A computer-readable, non-transitory recording medium storing program code for causing one or more processors to execute:
generating, based on voltage information on a voltage applied to a piezoelectric element of nozzles in a liquid discharge head that discharges liquid according to a drive signal input to the liquid discharge head, the drive signal and outputting the drive signal to the liquid discharge head;
acquiring, based on droplet speed information acquired from a droplet speed measuring device that measures a discharge speed of a droplet discharged from the liquid discharge head and the voltage information, appropriate voltage information on a voltage at which the discharge speed falls within a predetermined range; and
acquiring, from a memory that stores the appropriate voltage information in association with identification information of the nozzles and a drive frequency of the nozzles, the appropriate voltage information corresponding to the identification information and the drive frequency and outputting the drive signal based on the appropriate voltage information.
